(19) United States
(12) Patent Application Publication
(10) Pub. No.: US 2012/0123799 A1
(43) Pub. Date: May 17, 2012

(54) INTERACTIVE ORGAN DIAGRAMS

(75) Inventors: JOHN DAVID LARKIN NOLEN, PRAIRIE VILLAGE, KS (US); ALEXANDER MEDAS, ASHLAND, MA (US)

(73) Assignee: CERNER INNOVATION, INC., OVERLAND PARK, KS (US)

(21) Appl. No.: 12/946,116

(22) Filed: Nov. 15, 2010

(51) Int. Cl. G06Q 50/00

(52) U.S. Cl. 705/3

(57) ABSTRACT

An interactive organ diagram facilitates that input of clinically-related data regarding the condition of a patient's organ and storage of the clinically-related data in a patient's electronic medical record. The interactive organ diagram includes a graphical depiction of an organ with data entry elements that allow for the entry of data directly within the graphical depiction of the organ. After a pathologist or other clinician enters data directly within the graphical depiction of the organ, data from the interactive organ diagram may be stored in the patient's electronic medical record.

### BACKGROUND

The diagnosis of many diseases, such as prostate cancer or bladder cancer, often involves performing a biopsy on a patient's organ to collect tissue samples. The tissue samples are then analyzed by a pathologist who records discrete parameters such as a growth score or extent of organ involvement. Often, tissue samples are collected from various regions or areas of the patient's organ. As the pathologist analyzes each tissue sample, the pathologist must track the analysis according to which area of the organ the tissue sample was removed. Traditionally, the pathologist records observations for each region of the organ on a piece of paper, with subsequent dictation of values into the clinical report for the patient and incorporation into the patient's paper chart. Unfortunately, this approach presents a number of opportunities for error.

### BRIEF SUMMARY

Embodiments of the present invention relate to an interactive organ diagram that facilitates the entry of clinically-related data regarding the condition of a patient's organ and storage of the clinically-related data in the patent's electronic medical record. The interactive organ diagram provides a graphical depiction of an organ. A pathologist or other clinician may enter data regarding the condition of a patient's organ directly within the graphical depiction of the organ using data entry elements. Data may then be automatically transferred from the interactive organ diagram directly into the patient's electronic medical record.

Accordingly, in one aspect, an embodiment of the present invention is directed to one or more computer storage media storing computer-useable instructions that, when used by a computing device, cause the computing device to perform a method. The method includes providing an interactive organ diagram for display to a user, the interactive organ diagram comprising a graphical depiction of an organ. The method also includes receiving user input directly within at least a portion of the interactive organ diagram, the user input comprising a discrete data element regarding a condition of a patient's organ. The method further includes storing data from the interactive organ diagram in a patient's electronic medical record.

In another embodiment, an aspect of the invention is directed to one or more computer storage media storing computer-useable instructions that, when used by a computing device, cause the computing device to perform a method. The method includes providing an interactive organ diagram for display to a user, the interactive organ diagram comprising a graphical depiction of an organ divided into a plurality of areas. The method also includes receiving user input directly within a first area of the graphical depiction of the organ in the interactive organ diagram, the user input comprising a discrete data element regarding a condition of an area of a patient's organ corresponding with the first area of the graphical depiction of the organ in which the user input is received. The method further includes validating the discrete data element from the user input. The method also includes receiving a user command to preview an image object comprising the graphical depiction of the organ and the validated discrete data element displayed within the first area of the graphical depiction of the organ, and providing the image object for display to the user. The method further includes receiving a user command to submit data from the interactive organ diagram to a patient's electronic medical record. The method still further includes storing data from the interactive organ diagram in the patient's electronic medical record.

A further embodiment of the present invention is directed to a method in a clinical computing environment for providing an interactive organ diagram for entering data regarding diagnosis of a patient's organ. The method includes receiving a user selection of an interactive organ diagram. The method also includes providing the interactive organ diagram for display to a clinician on a display device, the interactive organ diagram comprising a graphical depiction of an organ divided into a plurality of areas, each area including one or more data input elements for receiving data. The method further includes receiving a discrete data element via a first data input element within a first area of the graphical depiction of the organ. The method still further includes storing data including at least the discrete data element from the interactive organ diagram in a patient's electronic medical record.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a flow diagram showing a method for employing an interactive organ diagram to enter data regarding the condition of a patient's organ in accordance with an embodiment of the present invention;

FIG. 3 is a flow diagram showing a method for storing an image object created from an interactive organ diagram in accordance with an embodiment of the present invention;

FIG. 4 is a flow diagram showing a method for populating a patient's electronic medical record with discrete data elements from an interactive organ diagram in accordance with an embodiment of the present invention; and

FIGS. 5A-5C are screen displays showing an interactive organ diagram in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide computerized systems, methods, and user interfaces for an interactive organ diagram. The interactive organ diagram is a graphical depiction of an organ, such as a prostate, liver, or bladder, to name a few. In some embodiments, the organ in the interactive organ diagram is divided into a number of different areas or regions. Each area of the organ in the interactive organ diagram includes data entry elements that allow a pathologist or other clinician to enter clinically-related data directly within the graphical depiction of the organ. The interactive organ diagram may include data entry elements corresponding with any number of conditions, such as, for instance, cancer, organ function, and infectious disease, to name a few. The clinically-related data entered by the pathologist or clinician corresponds with a diagnosed condition of the patient's organ.

In operation, the pathologist or other clinician examines tissue samples collected from a patient's organ. Each tissue sample may have been collected from a different area of the patient's organ. As the pathologist or clinician examines a given tissue sample, the pathologist or clinician may determine an area of an organ in an interactive organ diagram corresponding with the area from which the tissue sample was collected from the patient's organ. The pathologist or clinician may then employ the data entry elements within that area of the organ of the interactive organ diagram to enter a diagnosis made from the tissue sample. This process may be repeated for each tissue sample collected from the patient's organ.

After data is entered into the interactive organ diagram, data from the interactive organ diagram may be stored in the patient's electronic medical record. In some embodiments, an image object may be created from the interactive organ diagram that includes a graphical depiction of an organ with data elements entered by the pathologist or clinician. The image object may then be stored in the patient's electronic medical record. In other embodiments, discrete data elements may be extracted from the interactive organ diagram, automatically mapped to appropriate locations in the patient's electronic medical record, and stored accordingly.

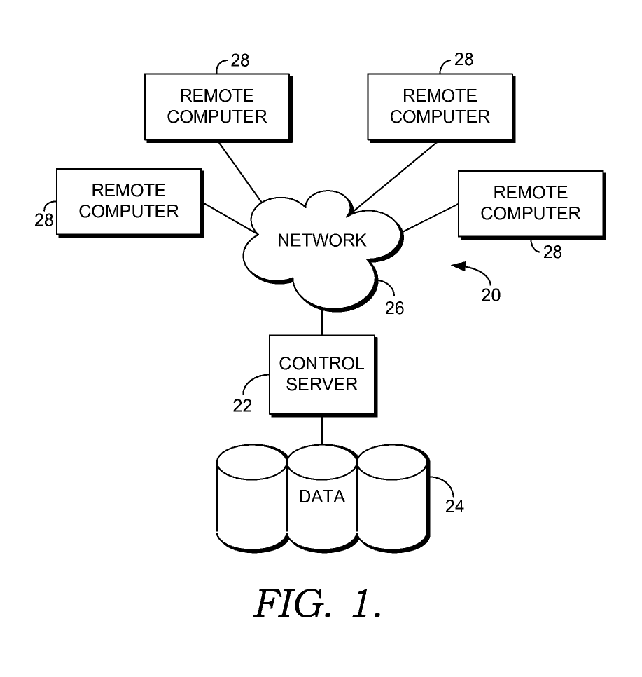

Referring to the drawings in general, and initially to FIG. 1 in particular, an exemplary computing system environment, for instance, a medical information computing system, on which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 20 includes a general purpose computing device in the form of a server 22. Components of the server 22 may include, without limitation, a processing unit, internal system memory, and a suitable system bus for coupling various system components, including database cluster 24, with the server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 22 typically includes, or has access to, a variety of computer readable media, for instance, database cluster 24. Computer readable media can be any available media that may be accessed by server 22, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for the server 22.

The server 22 may operate in a computer network 26 using logical connections to one or more remote computers 28. Remote computers 28 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 28 may also be physically located in non-traditional medical care environments so that the entire health care community may be capable of integration on the network. The remote computers 28 may be personal computers, servers, routers, network PCs, peer devices, other common network nodes, or the like, and may include some or all of the components described above in relation to the server 22. The devices can be personal digital assistants or other like devices.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the server 22 may include a modem or other means for establishing communications over the WAN, such as the Internet. In a networked environment, program modules or portions thereof may be stored in the server 22, in the database cluster 24, or on any of the remote computers 28. For example, and not by way of limitation, various application programs may reside on the memory associated with any one or more of the remote computers 28. It will be appreciated by those of ordinary skill in the art that the network connections shown are exemplary and other means of establishing a communications link between the computers (e.g., server 22 and remote computers 28) may be utilized.

In operation, a user may enter commands and information into the server 22 or convey the commands and information to the server 22 via one or more of the remote computers 28 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 22. In addition to a monitor, the server 22 and/or remote computers 28 may include other peripheral output devices, such as speakers and a printer.

Although many other internal components of the server 22 and the remote computers 28 are not shown, those of ordinary skill in the art will appreciate that such components and their interconnection are well known. Accordingly, additional details concerning the internal construction of the server 22 and the remote computers 28 are not further disclosed herein.

As previously mentioned, embodiments of the present invention relate to an interactive organ diagram that allows a pathologist or other clinician to enter clinically-related data directly within a graphical depiction of an organ. The data entered into the interactive organ diagram may then be used to populate a patient's electronic medical record.

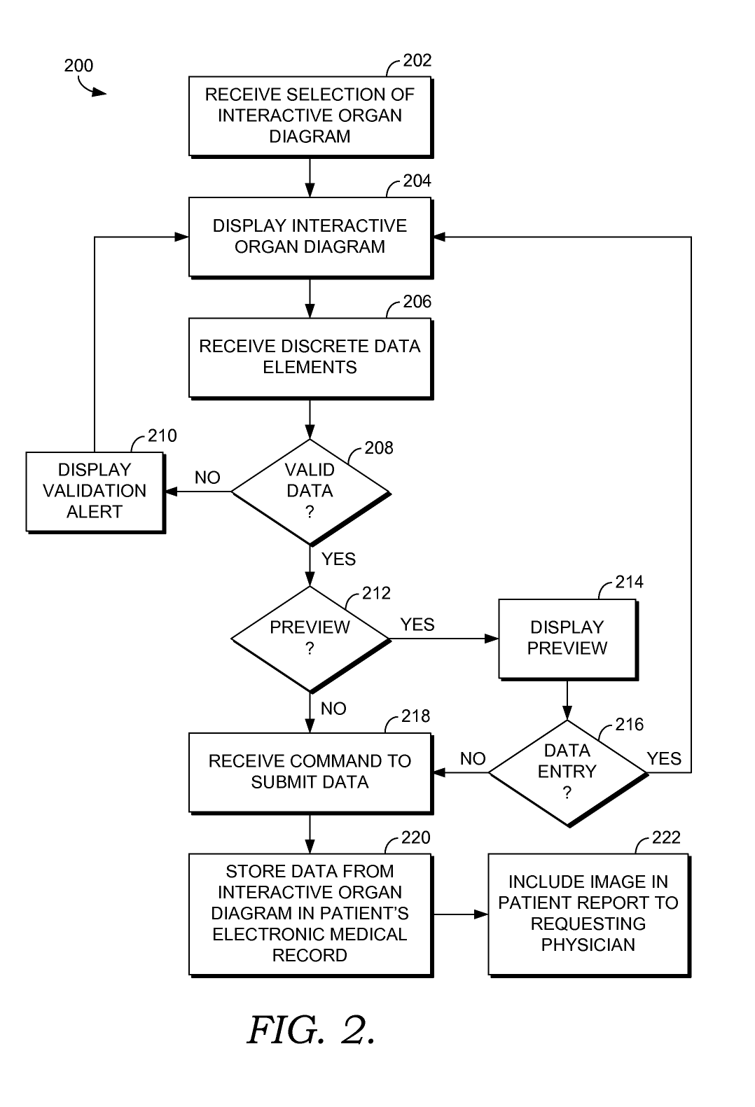

Referring now to FIG. 2, a flow diagram is provided that illustrates a method 200 for employing an interactive organ diagram to record data regarding the condition of a patient's organ in accordance with an embodiment of the present invention. As shown at block 202, the process may begin when a pathologist or other clinician selects a particular interactive organ diagram. As discussed previously, an interactive organ diagram includes a graphical depiction of an organ that is displayed on a display device and allows entry of data by pathologists or other clinicians directly within the graphical depiction of the organ.

Any of a variety of different organs may be represented by an interactive organ diagram within the scope of embodiments of the present invention. By way of example only and not limitation, the interactive organ diagram may be a graphical depiction of a prostate, bladder, liver, or other organ. Additionally, the interactive organ diagram may facilitate examination of a number of different clinical conditions, such as, for example, cancer, organ function, and infectious disease, to name a few. As such, embodiments of the present invention may provide a number of different interactive organ diagrams corresponding with different organs and different conditions. In various embodiments, an interactive organ diagram for a particular organ may facilitate entry of data for a single condition or multiple conditions.

The pathologist or other clinician may select a particular interactive organ diagram at block 202 in a number of different manners. For instance, the pathologist or clinician may simply specify an organ being examined. Alternatively, the pathologist or clinician may specify both the organ being examined and the clinical condition for which the organ is being analyzed.

Based on the pathologist's or clinician's selection at block 202, an appropriate interactive organ diagram is generated and displayed, as shown at block 204. The interactive organ diagram includes a graphical depiction of an organ that is displayed on a display device. Additionally, the interactive organ diagram provides user interface elements that allow the pathologist or clinician to enter data directly within the graphical depiction of the organ. In some embodiments, the user interface elements are data entry elements that correspond with the type of clinical condition specified by the pathologist at block 202.

The graphical depiction of the organ may be divided into a number of different areas or regions in some embodiments of the present invention. Each area of the organ in the interactive organ diagram corresponds with an area of a patient's organ from which a tissue sample may be taken and analyzed by a pathologist or other clinician. Additionally, each area of the organ in the interactive organ diagram is configured to receive data elements entered by a pathologist or other clinician. In particular, the pathologist or clinician may review the tissue sample collected from a particular area of a patient's organ and directly enter data from the analysis into an area of the organ in the interactive organ diagram corresponding with the particular area of the patient's organ being analyzed. The pathologist or clinician may repeat this process for each tissue sample collected by analyzing the tissue sample and entering data directly into an area of the organ in the interactive organ diagram corresponding with an area of the patient's organ from which each sample was collected.

Accordingly, as shown at block 206, discrete data elements are received directly within the graphical depiction of the organ of the interactive organ diagram. As noted above, depending on the type of organ being analyzed and the particular condition being examined, the interactive organ diagram may facilitate entry of different types of data. Additionally, discrete data elements may be entered within various areas of the graphical depiction of the organ corresponding with different areas of the patient's organ from which tissue samples were collected. In some instances, tissue samples may have only been collected from a few areas of the patient's organ. As such, data may only be entered within a few areas of the organ in the interactive organ diagram while data entry elements of other areas are left incomplete since no data is available for those areas.

Some embodiments of the present invention include a data validation feature. In particular, the data elements entered by the pathologist or other clinician may be checked to verify that valid data is entered. For instance, the system may verify that numerical values entered are within a valid range or that data entered is complete. As shown at block 208, a determination of whether the entered data is valid is made. The validation may occur at a number of locations within the process in various embodiments. For instance, validation may occur after each discrete data element is entered or after all data elements have been entered but prior to saving the data to a patient's electronic medical record. If invalid data is detected, a validation error alert is presented, as shown at block 210, and the pathologist or clinician may reenter the data as shown by the return to block 204. Alternatively, if the entered data is valid, the process continues without providing a validation error alert.

The pathologist or clinician may wish to preview an image object that presents the graphical depiction of an organ with the results of the analysis. In some embodiments, the results may simply include the data entered by the pathologist of other clinician. In other embodiments, the system may perform calculations based on the entered data and present the results of the calculations within the various areas of the graphical depiction of the organ. If it is determined at block 212 that the pathologist or clinician wishes to view a preview, a preview is presented, as shown at block 214.

After previewing, the pathologist or clinician may wish to continue to enter data and/or to correct data. As such, selection of further data entry may be detected at block 216, and the interactive organ diagram is displayed again allowing for further entry and/or correction of data.

At some point, the pathologist or clinician may wish to submit data from the interactive organ diagram to the patient's electronic medical record. As shown at block 218, a command is received to store data from the interactive organ diagram. Based on the command, data from the interactive organ diagram is stored in the patient's electronic medical record, as shown at block 220. Additionally, an image that includes the graphical depiction of the organ with the entered data is included in the patient report that is provided to the physician requesting the analysis of the patient's organ to be performed, as shown at block 222. This may be the physician treating the patient who may use the data to determine a proper course of treatment based on the results.

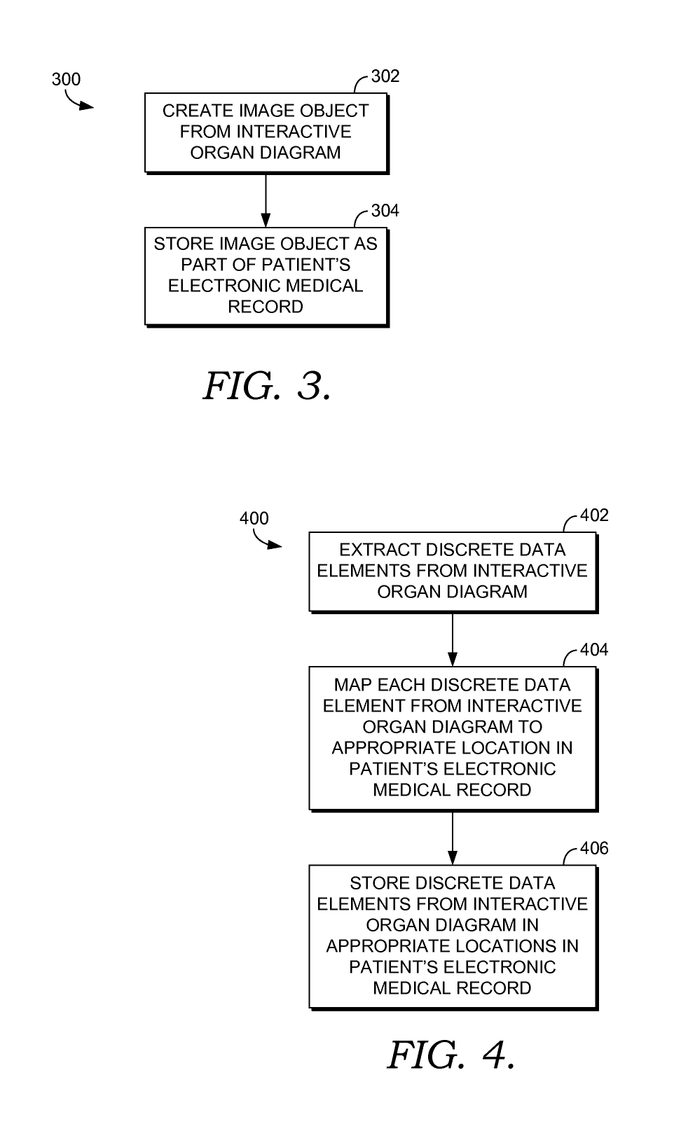

Data from the interactive organ diagram may be stored in the patient's electronic medical record in a number of different ways in accordance with various embodiments of the present invention. By way of example only and not limitation, FIGS. 3 and 4 illustrate two approaches for storing data from an interactive organ diagram in a patient's electronic medical record. With reference initially to FIG. 3, a flow diagram is provided that illustrates a method 300 for creating an image object and storing the image object as part of the patient's electronic medical record. Initially, as shown at block 302, an image object is created from the interactive organ diagram. The image object created at block 302 may be similar to the preview presented to the pathologist or clinician discussed above with reference to FIG. 2. In particular, the image object may include a graphical depiction of an organ divided into different areas with data shown within one or more of those areas depending on the data elements entered by the pathologist or clinician. The data may include the data elements entered by the pathologist or clinician and/or results of calculations performed on the entered data. The image object is stored as part of the patient's electronic medical record, as shown at block 304.

FIG. 4 provides a flow diagram illustrating a method 400 for extracting discrete data elements from an interactive organ diagram and using the discrete data elements to populate different areas of the patient's electronic medical record. As shown in FIG. 4, this process may include extracting discrete data elements from each area of the organ within the interactive organ diagram at block 402. The discrete data elements extracted from the interactive organ diagram may include the data elements entered by the pathologist or clinician and/or results of calculations performed on the entered data.

As shown at block 404, each discrete data element extracted from the interactive organ diagram is mapped to an appropriate location in the patient's electronic medical record based on the area of the graphical depiction of the organ from which each discrete data element was extracted. For instance, a discrete data element from the left lateral base portion of the interactive organ diagram for a prostate may be mapped to a location within the patient's electronic medical record pertaining to the left lateral base of the patient's prostate. Each discrete data element from the interactive organ diagram is then stored in the appropriate location in the patient's electronic medical record based on the determined mapping, as shown at block 406.

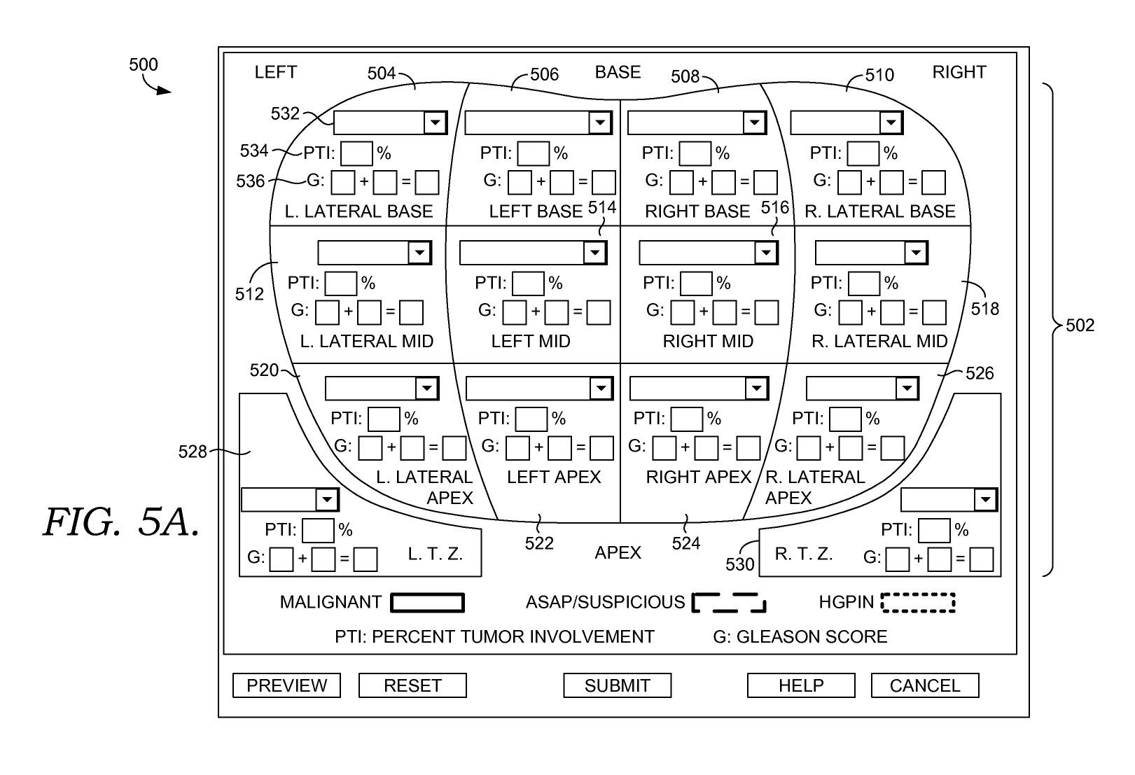

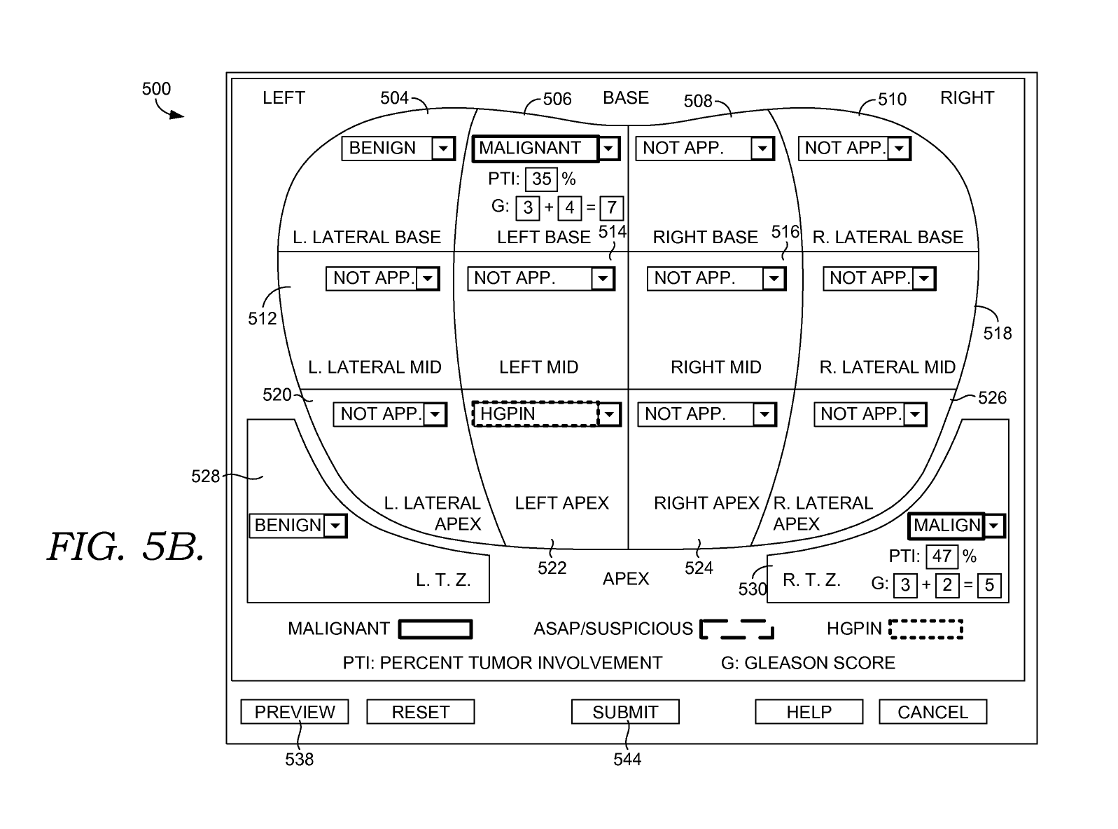

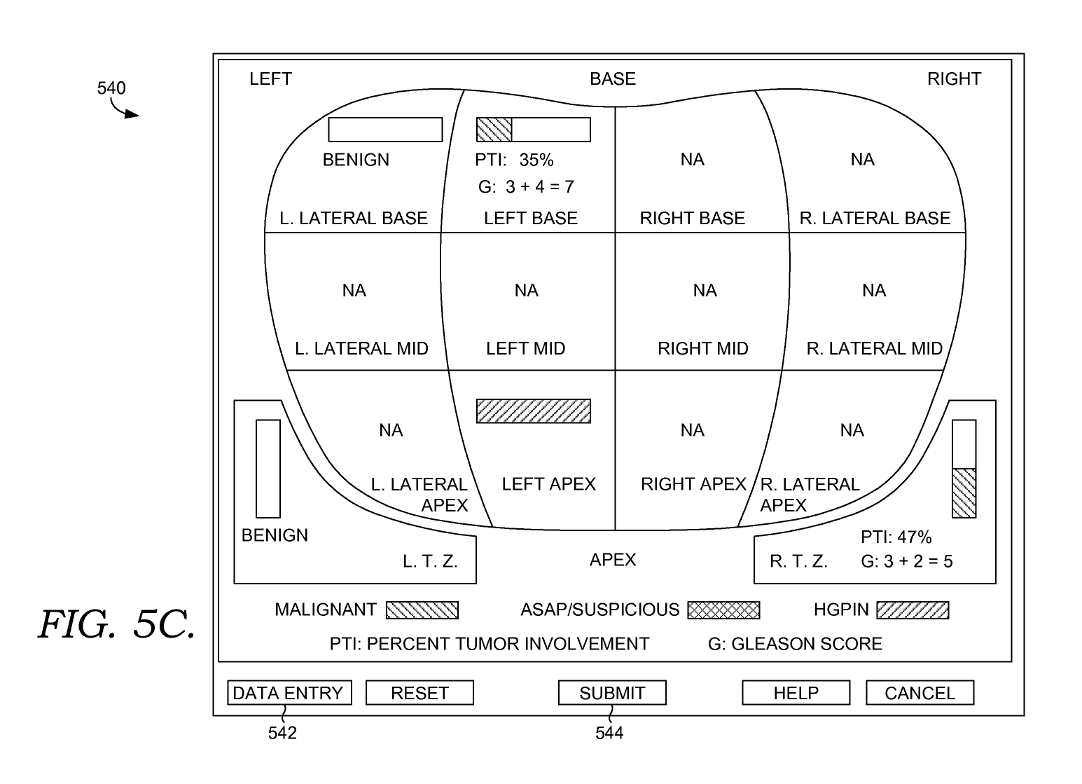

An example of an interactive organ diagram will now be described with reference to FIGS. 5A-5C, which include screen displays illustrating an interactive organ diagram for entering cancer-related data for a patient's prostate. It will be understood and appreciated by those of ordinary skill in the art that the screen displays of FIGS. 5A-5C are provided by way of example only and are not intended to limit the scope of the present invention in any way. For instance, although the interactive organ diagram shown in FIGS. 5A-5C illustrates entry of cancer-related data for a prostate, interactive organ diagrams may be provided that depict other types of organs and/or facilitate the entry of different types of clinically-related data.

FIG. 5A illustrates an interactive organ diagram 500 when initially accessed by a pathologist. As shown in FIG. 5A, the interactive organ diagram includes a graphical depiction 502 of a prostate. The graphical depiction is divided into a number of areas, including a left lateral base 504, left base 506, right base 508, right lateral base 510, left lateral mid 512, left mid 512, right mid 516, right lateral mid 518, left lateral apex 520, left apex 522, right apex 524, right lateral apex 526, left transition zone 528, and right transition zone 530. It should be understood that the graphical depiction 504 of the prostate may be divided in other manners.

Each of the areas 504, 506, 508, 510, 512, 514, 516, 518, 520, 522, 524, 526, 528, and 530 includes data entry elements 532, 534, and 536 that allow the pathologist to enter data determined from the pathologist's examination of a tissue sample from a corresponding area of a patient's prostate. Data entry element 532 includes a drop down box that allows the pathologist to select from one of the following options corresponding with the pathologist's diagnosis: benign, malignant, ASAP (atypical small acinar proliferation), and HGPIN (high grade prostatic interaepithelial neoplasia). Data entry element 534 allows the pathologist to enter a percent tumor involvement (PTI). Data entry element 536 allows the pathologist to enter a Gleason score.

As the pathologist examines tissue samples taken from the patient's prostate, the pathologist may employ data entry elements 532, 534, and/or 536 to directly enter data regarding the condition of different areas of the patient's prostate. FIG. 5B illustrates the interactive organ diagram 500 after the pathologist has entered data for various areas. For instance, as shown in FIG. 5B, the pathologist has indicated a benign diagnosis for the left lateral base 504 and the left transition zone 528, a HGPIN diagnosis for the left apex 522, and a malignant diagnosis with a PTI and Gleason score for each of the left base 506 and the right transition zone 530. No data has been entered for the other areas. For instance, tissue samples may not have been collected for those areas.

At any time while entering data into the interactive organ diagram 500, the pathologist may select the preview button 538 to view a preview of an image object of the graphical depiction with the diagnosis values. For instance, when the pathologist selects the preview button 538, an image object 540 such as that shown in FIG. 5C is displayed. The pathologist may review the values. If the pathologist wishes to edit data or enter new data, the pathologist may select the data entry button 542, which would return to the interactive organ diagram 500. When the pathologist has completed the evaluation, the pathologist may select the submit button 544 to submit data from the interactive organ diagram for storage in the patient's electronic medical record. As noted above, an image object generated from the interactive organ diagram may be stored in the patient's electronic medical record, and/or discrete data elements may be extracted from the interactive organ diagram and used to populate the patient's electronic medical record.

As can be understood, embodiments of the present invention provide an interactive organ diagram that allows a pathologist or other clinician to enter clinically-related data directly within a graphical depiction of an organ. Embodiments of the present invention further allow data from an interactive organ diagram to be integrated into a patient's electronic medical record.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by a computing device, cause the computing device to perform a method comprising:
providing an interactive organ diagram for display to a user, the interactive organ diagram comprising a graphical depiction of an organ;
receiving user input directly within at least a portion of the interactive organ diagram, the user input comprising a discrete data element regarding a condition of a patient's organ; and
storing data from the interactive organ diagram in a patient's electronic medical record.

2. The one or more computer storage media of claim 1, wherein the method further comprises receiving a user indication of a type of organ, and wherein the interactive organ diagram provides a graphical depiction of the type of organ indicated.

3. The one or more computer storage media of claim 2, wherein the method further comprises receiving a user indication of a condition being evaluated, and wherein the interactive organ diagram includes one or more data input elements for entering clinical data associated with the condition being evaluated.

4. The one or more computer storage media of claim 1, wherein the graphical depiction of the organ is divided into a plurality of different areas in the interactive organ diagram.

5. The one or more computer storage media of claim 4, wherein receiving user input within at least a portion of the interactive organ diagram comprises receiving user input in one of the areas.

6. The one or more computer storage media of claim 1, wherein the method further comprises validating the discrete data element.

7. The one or more computer storage media of claim 1, wherein storing data from the interactive organ diagram in the patient's electronic medical record comprises:
creating an image object comprising the graphical depiction of the organ with the discrete data element from the user input; and
storing the image object in the patient's electronic medical record.

8. The one or more computer storage media of claim 1, wherein storing data from the interactive organ diagram in the patient's electronic medical record comprises:
extracting the discrete data element from the interactive organ diagram;
mapping the discrete data element from the interactive organ diagram to an appropriate location in the patient's electronic medical record; and
storing the discrete data element from the interactive organ diagram in the appropriate location in the patient's electronic medical record.

9. The one or more computer storage media of claim 1, wherein the user input comprises a plurality of discrete data elements received within the interactive organ diagram and wherein storing data from the interactive organ diagram in the patient's electronic medical record comprises:
extracting the discrete data elements from the interactive organ diagram;
mapping each discrete data element from the interactive organ diagram to an appropriate location in the patient's electronic medical record; and
storing each discrete data element from the interactive organ diagram in the appropriate location in the patient's electronic medical record.

10. The one or more computer storage media of claim 1, wherein the graphical depiction of the organ comprises a graphical depiction of an organ selected from the following: a prostate, a bladder, and a liver.

11. One or more computer storage media storing computer-useable instructions that, when used by a computing device, cause the computing device to perform a method comprising:
providing an interactive organ diagram for display to a user, the interactive organ diagram comprising a graphical depiction of an organ divided into a plurality of areas;
receiving user input directly within a first area of the graphical depiction of the organ in the interactive organ diagram, the user input comprising a discrete data element regarding a condition of an area of a patient's organ corresponding with the first area of the graphical depiction of the organ in which the user input is received;
validating the discrete data element from the user input;
receiving a user command to preview an image object comprising the graphical depiction of the organ and the validated discrete data element displayed within the first area of the graphical depiction of the organ;
providing the image object for display to the user;
receiving a user command to submit data from the interactive organ diagram to a patient's electronic medical record; and
storing data from the interactive organ diagram in the patient's electronic medical record.

12. The one or more computer storage media of claim 11, wherein the method further comprises receiving a user indication of a type of organ, and wherein the interactive organ diagram provides a graphical depiction of the type of organ indicated.

13. The one or more computer storage media of claim 12, wherein the method further comprises receiving a user indication of a condition being evaluated, and wherein the interactive organ diagram includes one or more data input elements for entering clinical data associated with the condition being evaluated.

14. The one or more computer storage media of claim 11, wherein storing data from the interactive organ diagram in the patient's electronic medical record comprises storing the image object in the patient's electronic medical record.

15. The one or more computer storage media of claim 11, wherein storing data from the interactive organ diagram in the patient's electronic medical record comprises:
extracting the discrete data element from the interactive organ diagram;
mapping the discrete data element from the interactive organ diagram to an appropriate location in the patient's electronic medical record; and
storing the discrete data element from the interactive organ diagram in the appropriate location in the patient's electronic medical record.

16. The one or more computer storage media of claim 11, wherein the user input comprises a plurality of discrete data elements received within various areas of the interactive organ diagram and wherein storing data from the interactive organ diagram in the patient's electronic medical record comprises:
extracting the discrete data elements from the interactive organ diagram;
mapping each discrete data element from the interactive organ diagram to an appropriate location in the patient's electronic medical record; and
storing each discrete data element from the interactive organ diagram in the appropriate location in the patient's electronic medical record.

17. A method in a clinical computing environment for providing an interactive organ diagram for entering data regarding diagnosis of a patient's organ, the method comprising:
receiving a user selection of an interactive organ diagram;
providing the interactive organ diagram for display to a clinician on a display device, the interactive organ diagram comprising a graphical depiction of an organ divided into a plurality of areas, each area including one or more data input elements for receiving data;
receiving a discrete data element via a first data input element within a first area of the graphical depiction of the organ; and
storing data including at least the discrete data element from the interactive organ diagram in a patient's electronic medical record.

18. The method of claim 17, wherein receiving the user selection of an interactive organ diagram comprises receiving a user indication of a type of organ and a condition being evaluated, and wherein the graphical depiction of the organ comprises a depiction of the type of organ indicated and wherein the one or more data input elements correspond with the condition being evaluated.

19. The method of claim 17, wherein storing data from the interactive organ diagram in the patient's electronic medical record comprises:
creating an image object comprising the graphical depiction of the organ with the discrete data element; and
storing the image object in the patient's electronic medical record.

20. The method of claim 17, wherein storing data from the interactive organ diagram in the patient's electronic medical record comprises:
extracting the discrete data element from the interactive organ diagram;
mapping the discrete data element from the interactive organ diagram to an appropriate location in the patient's electronic medical record; and
storing the discrete data element from the interactive organ diagram in the appropriate location in the patient's electronic medical record.
